(19) United States
(12) Patent Application Publication
(10) Pub. No.: US 2015/0199833 A1
(43) Pub. Date: Jul. 16, 2015

(54) HARDWARE SUPPORT FOR DISPLAY FEATURES

(71) Applicant: NVIDIA CORPORATION, Santa Clara, CA (US)

(72) Inventors: William T. WARNER, Sunnyvale, CA (US); Michael I. GOLD, Santa Clara, CA (US); Karan GUPTA, Noida (IN)

(73) Assignee: NVIDIA CORPORATION, Santa Clara, CA (US)

(21) Appl. No.: 14/152,514

(22) Filed: Jan. 10, 2014

(51) Int. Cl. G06T 11/60; G06T 1/20; G06T 7/00

(52) U.S. Cl. CPC G06T 11/60; G06T 7/0051; G06T 1/20

(57) ABSTRACT

One embodiment of the present invention sets forth a system for displaying images including a hardware display controller engine that receives a rendered image. The system also includes an output compositor that composites a first image and the rendered image to create a second composited image. Finally, the system includes a display to display the second composited image.

### BACKGROUND OF THE INVENTION

1. Field of the Invention

Embodiments of the present invention relate generally to display technology, and, more specifically, to a hardware support for displaying composited images on a display screen.

2. Description of the Related Art

A number of device displays, particularly touch screen displays associated with mobile devices such as cellular phones or tablet computers, utilize multiple “windows” or surfaces on the screen to display different items. For example, a status bar at the top of a cellular phone display may be one window, the background wallpaper of the display may be another window, and soft buttons may comprise another window. Soft buttons replace the physical front buttons on the device with a conceptual touch-based display window on the screen, composited with the other windows.

A conventional approach to support the soft button window is to composite that window with other windows using an external 2D or 3D engine. In the conventional approach, several software tasks each draw an image or window. A compositor combines these images and the result is stored in a frame buffer. A display controller fetches the resultant combination out of the frame buffer and sends it to the display. The conventional approach therefore involves one or more fetch operations, then a composite operation, then a write-back to the frame buffer, then another fetch, and finally the result is displayed.

One major drawback with the conventional approach is that compositing in the manner described above requires an extra memory pass, which costs memory bandwidth and power.

Accordingly, what is needed in the art is a more effective technique for displaying composited images on a display.

### SUMMARY OF THE INVENTION

One embodiment of the present invention sets forth a method for displaying images. The method includes transmitting one or more images to a first compositor. The method also includes composting the one or more images to create a first composited image. The method also includes transmitting a rendered image and the first composited image to a second compositor. The method also includes composting the rendered image and the first composited image at the second compositor to produce a second composited image. Finally, the method includes transmitting the second composited image to a display.

Another embodiment of the present invention sets forth a system for displaying images including a hardware display controller engine that receives a rendered image. The system also includes an output compositor that composites a first image and the rendered image to create a second composited image. Finally, the system includes a display to display the second composited image.

One advantage of the disclosed techniques is that the number of memory reads and writes is reduced. This can result in memory bandwidth savings, power savings, and/or reduced latency.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram illustrating a computer system configured to implement one or more aspects of the present invention;

FIG. 2 is a block diagram of a parallel processing unit included in the parallel processing subsystem of FIG. 1, according to one embodiment of the present invention;

FIG. 3 illustrates a display controller with one dedicated hardware display controller engine in accordance with one example embodiment of the present invention;

FIG. 4 illustrates a display controller with two dedicated hardware display controller engines in accordance with one example embodiment of the present invention;

FIG. 5 illustrates a display controller with five dedicated hardware display controller engines in accordance with one example embodiment of the present invention;

FIG. 6 is a flow diagram of method steps for displaying an image, according to one embodiment of the present invention; and

FIG. 7 is a flow diagram of method steps for displaying an image, according to another embodiment of the present invention.

### DETAILED DESCRIPTION

In the following description, numerous specific details are set forth to provide a more thorough understanding of the present invention. However, it will be apparent to one of skill in the art that the present invention may be practiced without one or more of these specific details.

### System Overview

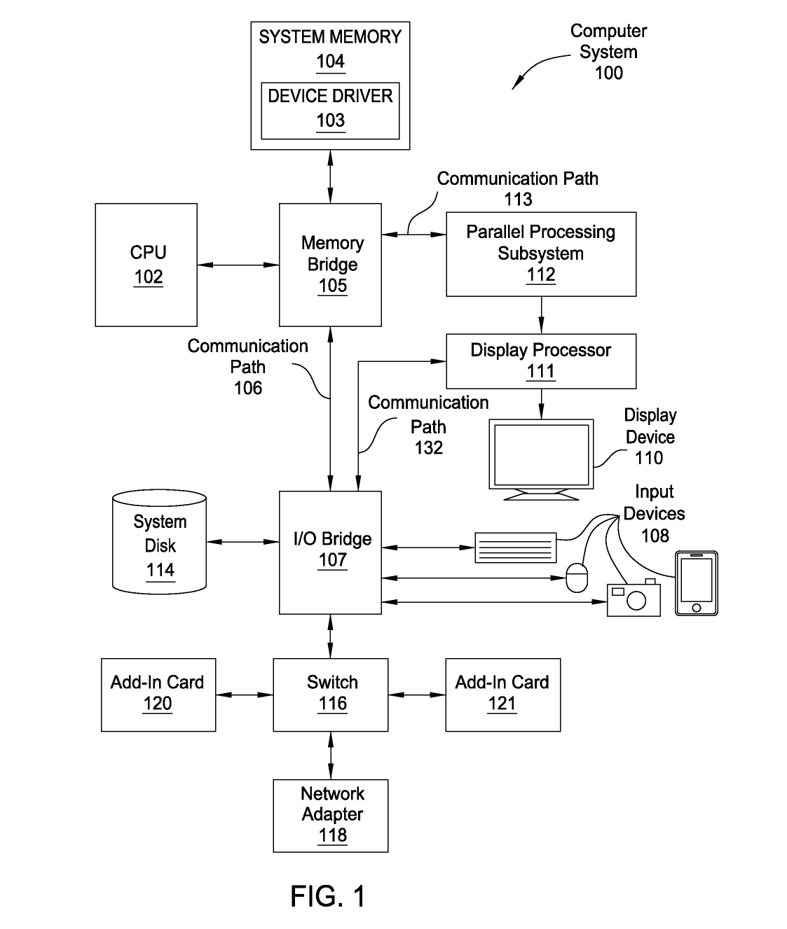

FIG. 1 is a block diagram illustrating a computer system 100 configured to implement one or more aspects of the present invention. As shown, computer system 100 includes, without limitation, a central processing unit (CPU) 102 and a system memory 104 coupled to a parallel processing subsystem 112 via a memory bridge 105 and a communication path 113. Memory bridge 105 is further coupled to an I/O (input/output) bridge 107 via a communication path 106, and I/O bridge 107 is, in turn, coupled to a switch 116.

In operation, I/O bridge 107 is configured to receive user input information from input devices 108, such as a keyboard, a mouse, and/or a camera and forward the input information to CPU 102 for processing via communication path 106 and memory bridge 105. I/O bridge 107 also may be configured to receive information from an input device 108, such as a camera, and forward the information to a display processor 111 for processing via communication path 132. In addition, I/O bridge 107 may be configured to receive information, such as synchronization signals, from the display processor 111 and forward the information to an input device 108, such as a camera, via communication path 132. Switch 116 is configured to provide connections between I/O bridge 107 and other components of the computer system 100, such as a network adapter 118 and various add-in cards 120 and 121.

As also shown, I/O bridge 107 is coupled to a system disk 114 that may be configured to store content and applications and data for use by CPU 102 and parallel processing subsystem 112. As a general matter, system disk 114 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. Finally, although not explicitly shown, other components, such as universal serial bus or other port connections, compact disc drives, digital versatile disc drives, film recording devices, and the like, may be connected to I/O bridge 107 as well.

In various embodiments, memory bridge 105 may be a Northbridge chip, and I/O bridge 107 may be a Southbridge chip. In addition, communication paths 106 and 113, as well as other communication paths within computer system 100, may be implemented using any technically suitable protocols, including, without limitation, AGP (Accelerated Graphics Port), HyperTransport, or any other bus or point-to-point communication protocol known in the art.

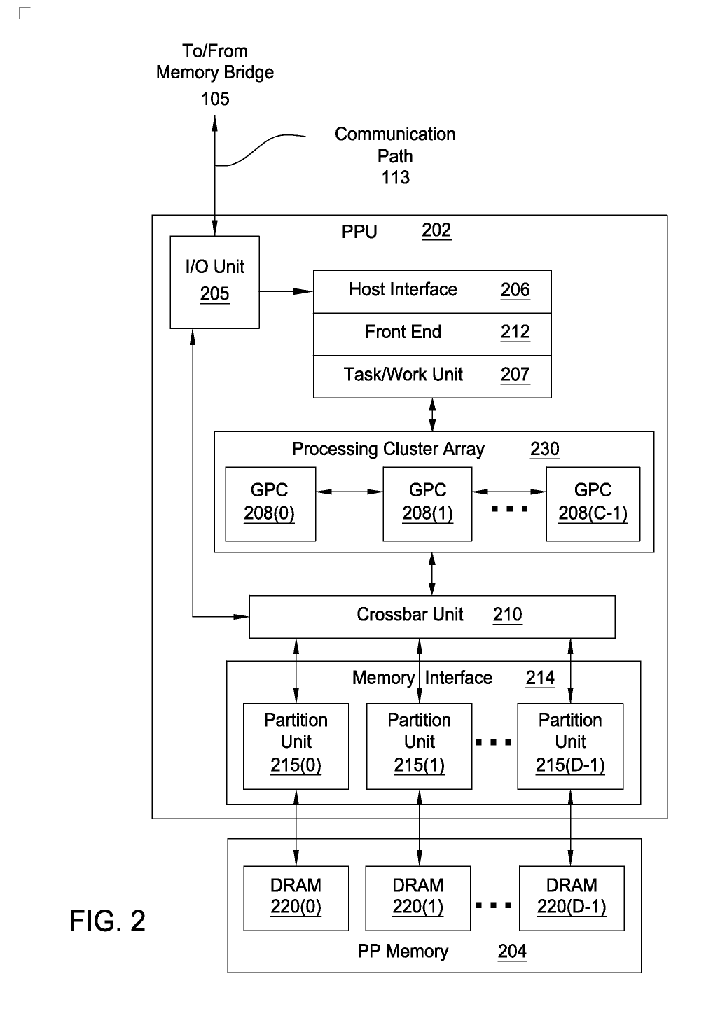

In some embodiments, parallel processing subsystem 112 comprises a graphics subsystem that delivers pixels to a display device 110 that may be any conventional cathode ray tube, liquid crystal display, light-emitting diode display, or the like. In such embodiments, the parallel processing subsystem 112 incorporates circuitry optimized for graphics and video processing, including, for example, video output circuitry. As described in greater detail below in FIG. 2, such circuitry may be incorporated across one or more parallel processing units (PPUs) included within parallel processing subsystem 112. In other embodiments, the parallel processing subsystem 112 incorporates circuitry optimized for general purpose and/or compute processing. Again, such circuitry may be incorporated across one or more PPUs included within parallel processing subsystem 112 that are configured to perform such general purpose and/or compute operations. In yet other embodiments, the one or more PPUs included within parallel processing subsystem 112 may be configured to perform graphics processing, general purpose processing, and compute processing operations. System memory 104 includes at least one device driver 103 configured to manage the processing operations of the one or more PPUs within parallel processing subsystem 112.

In various embodiments, parallel processing subsystem 112 may be integrated with one or more other the other elements of FIG. 1 to form a single system. For example, parallel processing subsystem 112 may be integrated with the, memory bridge 105, I/O bridge 107, display processor 111, and/or other connection circuitry on a single chip to form a system on chip (SoC).

It will be appreciated that the system shown herein is illustrative and that variations and modifications are possible. The connection topology, including the number and arrangement of bridges, the number of CPUs 102, and the number of parallel processing subsystems 112, may be modified as desired. For example, in some embodiments, system memory 104 could be connected to CPU 102 directly rather than through memory bridge 105, and other devices would communicate with system memory 104 via memory bridge 105 and CPU 102. In other alternative topologies, parallel processing subsystem 112 may be connected to I/O bridge 107 or directly to CPU 102, rather than to memory bridge 105. In still other embodiments, I/O bridge 107 and memory bridge 105 may be integrated into a single chip instead of existing as one or more discrete devices. Lastly, in certain embodiments, one or more components shown in FIG. 1 may not be present. For example, switch 116 could be eliminated, and network adapter 118 and add-in cards 120, 121 would connect directly to I/O bridge 107.

FIG. 2 is a block diagram of a parallel processing unit (PPU) 202 included in the parallel processing subsystem 112 of FIG. 1, according to one embodiment of the present invention. Although FIG. 2 depicts one PPU 202, as indicated above, parallel processing subsystem 112 may include any number of PPUs 202. As shown, PPU 202 is coupled to a local parallel processing (PP) memory 204. PPU 202 and PP memory 204 may be implemented using one or more integrated circuit devices, such as programmable processors, application specific integrated circuits (ASICs), or memory devices, or in any other technically feasible fashion.

In some embodiments, PPU 202 comprises a graphics processing unit (GPU) that may be configured to implement a graphics rendering pipeline to perform various operations related to generating pixel data based on graphics data supplied by CPU 102 and/or system memory 104. When processing graphics data, PP memory 204 can be used as graphics memory that stores one or more conventional frame buffers and, if needed, one or more other render targets as well. Among other things, PP memory 204 may be used to store and update pixel data and deliver final pixel data or display frames to display device 110 for display. In some embodiments, PPU 202 also may be configured for general-purpose processing and compute operations.

In operation, CPU 102 is the master processor of computer system 100, controlling and coordinating operations of other system components. In particular, CPU 102 issues commands that control the operation of PPU 202. In some embodiments, CPU 102 writes a stream of commands for PPU 202 to a data structure (not explicitly shown in either FIG. 1 or FIG. 2) that may be located in system memory 104, PP memory 204, or another storage location accessible to both CPU 102 and PPU 202. A pointer to the data structure is written to a pushbuffer to initiate processing of the stream of commands in the data structure. The PPU 202 reads command streams from the pushbuffer and then executes commands asynchronously relative to the operation of CPU 102. In embodiments where multiple pushbuffers are generated, execution priorities may be specified for each pushbuffer by an application program via device driver 103 to control scheduling of the different pushbuffers.

As also shown, PPU 202 includes an I/O (input/output) unit 205 that communicates with the rest of computer system 100 via the communication path 113 and memory bridge 105. I/O unit 205 generates packets (or other signals) for transmission on communication path 113 and also receives all incoming packets (or other signals) from communication path 113, directing the incoming packets to appropriate components of PPU 202. For example, commands related to processing tasks may be directed to a host interface 206, while commands related to memory operations (e.g., reading from or writing to PP memory 204) may be directed to a crossbar unit 210. Host interface 206 reads each pushbuffer and transmits the command stream stored in the pushbuffer to a front end 212.

As mentioned above in conjunction with FIG. 1, the connection of PPU 202 to the rest of computer system 100 may be varied. In some embodiments, parallel processing subsystem 112, which includes at least one PPU 202, is implemented as an add-in card that can be inserted into an expansion slot of computer system 100. In other embodiments, PPU 202 can be integrated on a single chip with a bus bridge, such as memory bridge 105 or I/O bridge 107. Again, in still other embodiments, some or all of the elements of PPU 202 may be included along with CPU 102 in a single integrated circuit or system of chip (SoC).

In operation, front end 212 transmits processing tasks received from host interface 206 to a work distribution unit (not shown) within task/work unit 207. The work distribution unit receives pointers to processing tasks that are encoded as task metadata (TMD) and stored in memory. The pointers to TMDs are included in a command stream that is stored as a pushbuffer and received by the front end unit 212 from the host interface 206. Processing tasks that may be encoded as TMDs include indices associated with the data to be processed as well as state parameters and commands that define how the data is to be processed. For example, the state parameters and commands could define the program to be executed on the data. The task/work unit 207 receives tasks from the front end 212 and ensures that GPCs 208 are configured to a valid state before the processing task specified by each one of the TMDs is initiated. A priority may be specified for each TMD that is used to schedule the execution of the processing task. Processing tasks also may be received from the processing cluster array 230. Optionally, the TMD may include a parameter that controls whether the TMD is added to the head or the tail of a list of processing tasks (or to a list of pointers to the processing tasks), thereby providing another level of control over execution priority.

PPU 202 advantageously implements a highly parallel processing architecture based on a processing cluster array 230 that includes a set of C general processing clusters (GPCs) 208, where C≧1. Each GPC 208 is capable of executing a large number (e.g., hundreds or thousands) of threads concurrently, where each thread is an instance of a program. In various applications, different GPCs 208 may be allocated for processing different types of programs or for performing different types of computations. The allocation of GPCs 208 may vary depending on the workload arising for each type of program or computation.

Memory interface 214 includes a set of D of partition units 215, where D≧1. Each partition unit 215 is coupled to one or more dynamic random access memories (DRAMs) 220 residing within PPM memory 204. In one embodiment, the number of partition units 215 equals the number of DRAMs 220, and each partition unit 215 is coupled to a different DRAM 220. In other embodiments, the number of partition units 215 may be different than the number of DRAMs 220. Persons of ordinary skill in the art will appreciate that a DRAM 220 may be replaced with any other technically suitable storage device. In operation, various render targets, such as texture maps and frame buffers, may be stored across DRAMs 220, allowing partition units 215 to write portions of each render target in parallel to efficiently use the available bandwidth of PP memory 204.

A given GPCs 208 may process data to be written to any of the DRAMs 220 within PP memory 204. Crossbar unit 210 is configured to route the output of each GPC 208 to the input of any partition unit 215 or to any other GPC 208 for further processing. GPCs 208 communicate with memory interface 214 via crossbar unit 210 to read from or write to various DRAMs 220. In one embodiment, crossbar unit 210 has a connection to I/O unit 205, in addition to a connection to PP memory 204 via memory interface 214, thereby enabling the processing cores within the different GPCs 208 to communicate with system memory 104 or other memory not local to PPU 202. In the embodiment of FIG. 2, crossbar unit 210 is directly connected with I/O unit 205. In various embodiments, crossbar unit 210 may use virtual channels to separate traffic streams between the GPCs 208 and partition units 215.

Again, GPCs 208 can be programmed to execute processing tasks relating to a wide variety of applications, including, without limitation, linear and nonlinear data transforms, filtering of video and/or audio data, modeling operations (e.g., applying laws of physics to determine position, velocity and other attributes of objects), image rendering operations (e.g., tessellation shader, vertex shader, geometry shader, and/or pixel/fragment shader programs), general compute operations, etc. In operation, PPU 202 is configured to transfer data from system memory 104 and/or PP memory 204 to one or more on-chip memory units, process the data, and write result data back to system memory 104 and/or PP memory 204. The result data may then be accessed by other system components, including CPU 102, another PPU 202 within parallel processing subsystem 112, or another parallel processing subsystem 112 within computer system 100.

As noted above, any number of PPUs 202 may be included in a parallel processing subsystem 112. For example, multiple PPUs 202 may be provided on a single add-in card, or multiple add-in cards may be connected to communication path 113, or one or more of PPUs 202 may be integrated into a bridge chip. PPUs 202 in a multi-PPU system may be identical to or different from one another. For example, different PPUs 202 might have different numbers of processing cores and/or different amounts of PP memory 204. In implementations where multiple PPUs 202 are present, those PPUs may be operated in parallel to process data at a higher throughput than is possible with a single PPU 202. Systems incorporating one or more PPUs 202 may be implemented in a variety of configurations and form factors, including, without limitation, desktops, laptops, handheld personal computers or other handheld devices, servers, workstations, game consoles, embedded systems, and the like.

### Hardware Support for Display Features

In the context of this disclosure, and as indicated above, components of computer system 100 shown in FIG. 1 and PPU 202 shown in FIG. 2 may be included within a mobile computing device, such as a cell phone or tablet computer. In addition, certain elements of computer system 100 may be incorporated into an SoC, including CPU 102 of FIG. 1 and PPU 202 of FIG. 2, among other elements.

As noted above, cellular phones, tablets, and other devices may use soft buttons located on the display instead of physical buttons. One example of a device is device 108 illustrated above in FIG. 1. Soft button images are composited against everything else on the screen (such as the desktop, other icons, etc.). Compositing the soft button images is an extra operation that has to be performed by software, which uses memory bandwidth, power, and other resources.

In one embodiment of the present invention, a display controller can implement dedicated soft button support. A dedicated hardware display controller engine can be used to fetch a rendered soft button image from memory and composite that image with the other windows, such as the status bar, wallpaper, icons, etc. All of the composited windows are then sent to the display panel for display.

In another embodiment, a dedicated hardware display controller engine can be used to fetch an image besides the soft button image. For example, the status bar could use the dedicated engine and the other windows, such as the button bar and the wallpaper, can be composited in software and then composited furtherwith the output of the dedicated engine (i.e., the status bar) for display.

In yet another embodiment, multiple dedicated hardware display controller engines may be used. For example, four dedicated engines may be used. If there are four or fewer windows to composite, each window can be assigned a dedicated engine and the outputs of each engine can be corn posited and sent to the display panel. If there are more windows than available engines, two or more of the windows can be composited in software or with a pixel processor, and then the output of that composition can be combined with the outputs of each dedicated engine for display.

As persons skilled in the art will appreciate, in other embodiments, any number of display controller engines may be implemented consistently with the descriptions of the embodiments described herein.

Among other things, using one or more dedicated hardware display controller engines can advantageously save power and memory bandwidth. Implementing hardware display controller engines can also reduce latency, which may improve overall system performance. Further, the disclosed techniques may reduce the complexity of the overall device for user by enabling more soft buttons to be implemented on the display in lieu of physical buttons.

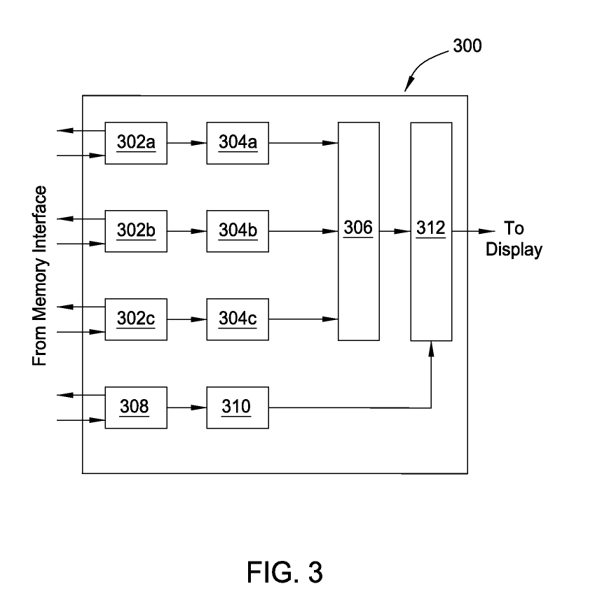

FIG. 3 illustrates a display controller 300 with one dedicated hardware display controller engine 308 in accordance with one example embodiment of the present invention. In this example, legacy DMA (direct memory access) engines 302a, 302b, and 302c communicate with one or more memories (not shown) through a memory interface to receive windows that will be displayed on the display. Dedicated hardware display controller engine 308 also communicates with one or more memories through a memory interface. Dedicated hardware display controller engine 308 is used to composite the soft buttons in hardware in this example embodiment. The soft button, or another image processed by a dedicated hardware display controller engine, may be referred to as a rendered image in certain example embodiments.

Display controller 300 also comprises pixel processors 304a, 304b, and 304c. These pixel processors perform pixel operations on data received from the DMA engines. Pixel processor 310 performs operations on data received from the dedicated hardware display controller engine 308.

The output of pixel processors 304a, 304b, and 304c is transmitted to legacy compositor 306. Compositor 306 combines the visual elements from the separate sources (i.e., the pixel processors 304a, 304b, and 304c) into a single image. In this example, compositing is a software process that can run on a CPU or a GPU. The visual elements from the separate sources may be composited serially based on visibility (i.e., background on bottom, icons on top, etc.). Images may be blended in order of depth, beginning with the closest image and ending with the furthest image. For example, icons may be blended earlier, and the background image later, because the icons will reside on top of the background in the final image on the display. Each pixel position on the display may be blended based on software instructions. Blending may be performed pixel by pixel.

Soft button compositor 312 composites the output of the legacy compositor 306 and the output of pixel processor 310. Soft button compositor 312 thus creates a single image that is sent to the display. Using a hardware display controller engine for at least one of the surfaces avoids an extra software operation of compositing an image, such as the button bar, onto the other content on the screen. Thus, using a hardware display controller engine can save power and memory bandwidth. Latency can also be reduced by using the direct hardware path instead of compositing.

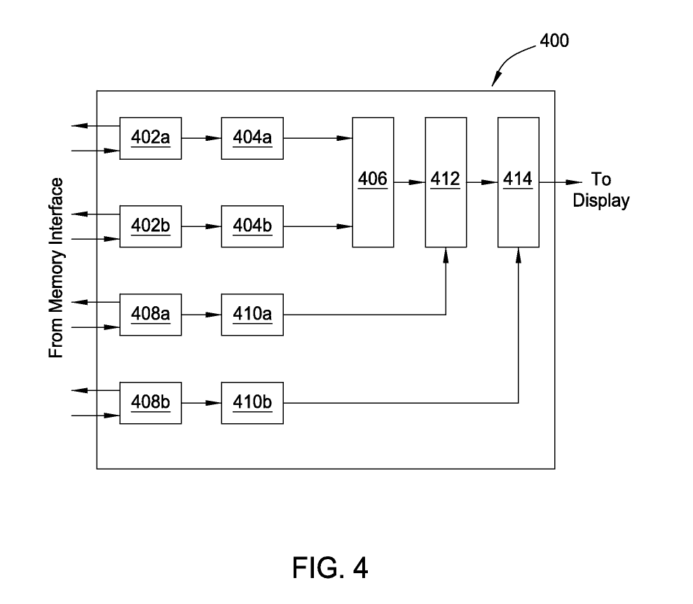

FIG. 4 illustrates a display controller 400 with two dedicated hardware display controller engines 408a and 408b in accordance with one example embodiment of the present invention. In this example, legacy DMA engines 402a and 402b communicate with one or more memories (not shown) through a memory interface to receive windows that will be displayed on the display. Dedicated hardware display controller engines 408a and 408b also communicate with one or more memories through a memory interface. Dedicated hardware display controller engines 408a and 408b are each used to composite an image in hardware in this example embodiment. For example, engine 408a may be used to composite a button bar and engine 408b may be used to composite a status bar.

Display controller 400 also comprises pixel processors 404a and 404b, which perform pixel operations on data received from the legacy DMA engines 402a and 402b. Pixel processors 410a and 410b perform operations on data received from the dedicated hardware display controller engines 408a and 408b.

The output of pixel processors 404a and 404b is transmitted to legacy compositor 406. Compositor 406 combines the visual elements from the separate sources (i.e., the pixel processors 404a and 404b) into a single image. In this example, compositing is a software process that can run on a CPU or a GPU.

Compositor 412 composites the output of the legacy compositor 406 and the output of pixel processor 410a. Then, compositor 414 composites the output of compositor 412 and the output of pixel processor 410b. Compositor 414 thus creates a single image that is sent to the display. Using hardware display controller engines for two of the surfaces avoids two extra software operations of compositing an image onto the other content on the screen. Thus, using multiple hardware display controller engines can save power and memory bandwidth. Latency can also be reduced by using the direct hardware path instead of compositing.

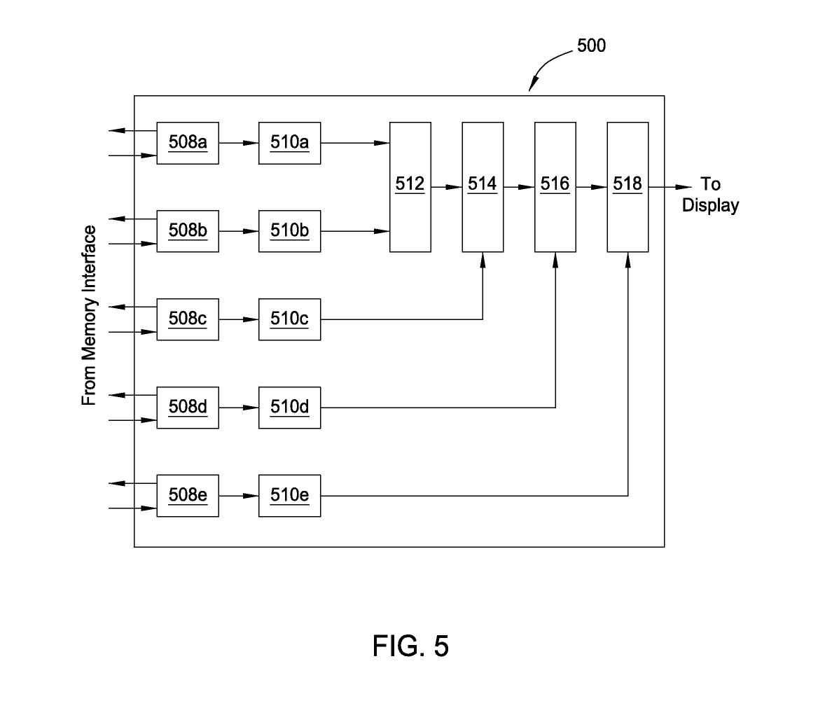

FIG. 5 illustrates a display controller 500 with five dedicated hardware display controller engines 508a-508e in accordance with one example embodiment of the present invention. Dedicated hardware display controller engines 508a-508e communicate with one or more memories through a memory interface. Dedicated hardware display controller engines 508a-508e are each used to fetch an image from memory and composite the image in hardware in this example embodiment. For example, one engine may be used for a button bar, one engine for a status bar, one engine for a background image on the display, one engine for icons, etc.

Pixel processors 510a-510b perform operations on data received from the dedicated hardware display controller engines 508a-508e. The outputs from the pixel processors are transmitted to the compositors 512, 514, 516, and 518 as shown in FIG. 5. The images from the hardware resources are composited serially as shown, and then the final composite image is sent to the display. This embodiment can save power and memory bandwidth and reduce latency as well.

In general, a display controller may have N resources and M surfaces to display. Certain embodiments of the invention optimize the mapping of resources to surfaces, using hardware display controller engines for directly fetching images. In one specific example, soft buttons (i.e., a rendered image) are fetched using the hardware display controller engine. If an embodiment has more surfaces than resources, some of the surfaces must be blended with one or more compositors, as illustrated in FIGS. 3 and 4. If an embodiment has more resources than surfaces, then the operations may be performed entirely in hardware, as illustrated in FIG. 5. Any technically feasible algorithm may be used to determine which surfaces are assigned to which resources. Various factors may be taken into account by such an algorithm, such as the impact on power consumption and memory bandwidth.

Pixel processors may also be used to composite two or more images and send the output directly to a display, in another embodiment. In this embodiment, the output of the pixel processors does not need to be written to memory and read back by a display controller. The pixel processors may render the image in a “real-time” display order.

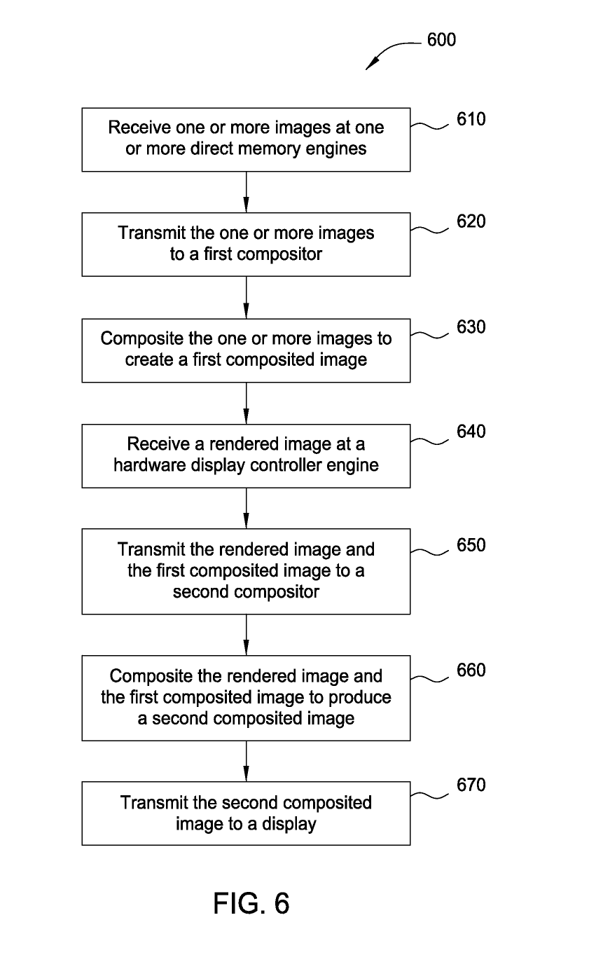

FIG. 6 is a flow diagram of method steps for displaying an image according to one embodiment of the present invention. Although the method steps are described in conjunction with FIGS. 1-4, persons skilled in the art will understand that any system configured to perform the method steps, in any order, falls within the scope of the present invention. In various embodiments, the hardware and/or software elements described above in FIGS. 1-4 can be configured to perform the method steps of FIG. 6.

As shown, a method 600 begins in step 610, where one or more direct memory access engines receive one or more images. The direct memory access engines can retrieve the images from a memory via a memory interface. The images may be transmitted on a bus between the memory and the direct memory access engines. Images can be created in some embodiments by software tasks and stored in memory. These images may comprise, for example, icons, backgrounds, task bars, status bars, etc. Any suitable number of direct memory access engines may be used in various embodiments.

In step 620, the direct memory access engines transmit the one or more images to a first compositor. In step 630, the first compositor composites the one or more images to create a first composited image. The compositing operation may be performed by compositing software running on a CPU or a GPU.

In step 640, a hardware display controller engine receives a rendered image. The hardware display controller engine can retrieve the image from a memory via a memory interface. The image may be transmitted on a bus between the memory and the hardware display controller engine. This image can also be created by a software task and stored in memory. In one example embodiment, this image comprises a button bar.

In step 650, the rendered image is sent by the hardware display controller engine to a second compositor. In addition, the first compositor transmits the first composited image to the second compositor. In step 660, the second compositor composites the rendered image and the first composited image to produce a second composited image.

In step 670, the second compositor transmits the second composited image to a display panel for display.

In sum, in the example embodiment illustrated in FIG. 6, a dedicated hardware display controller engine is used to fetch the rendered button bar image from a memory and composite it with the other images (wallpaper, status bar, icons, etc.) that were retrieved by the direct memory access engines. The final composited image is sent to the display. Because the fetching and composition for the button bar is supported inside the display controller and done, an extra memory pass can be saved. This can result in memory bandwidth and power savings, along with reducing latency.

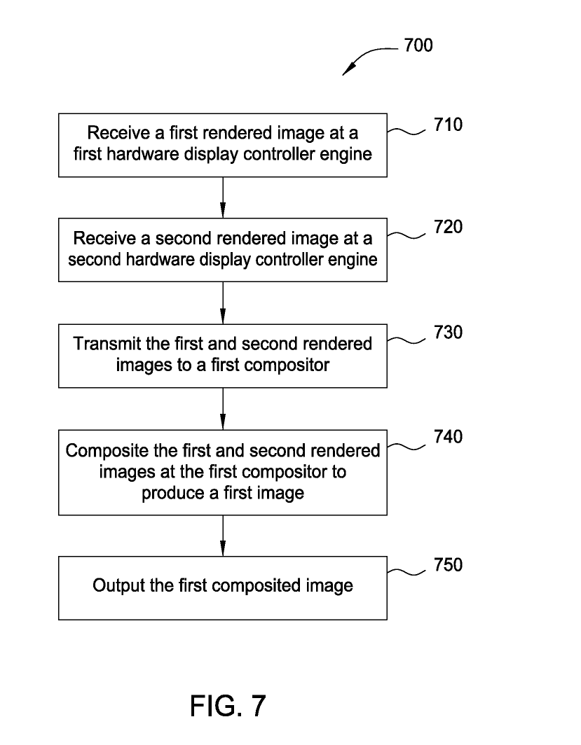

FIG. 7 is a flow diagram of method steps for displaying an image according to one embodiment of the present invention. Although the method steps are described in conjunction with FIGS. 1, 2, and 5, persons skilled in the art will understand that any system configured to perform the method steps, in any order, falls within the scope of the present invention. In various embodiments, the hardware and/or software elements described above in FIGS. 1, 2, and 5 can be configured to perform the method steps of FIG. 7.

As shown, a method 700 begins in step 710, where a first hardware display controller engine receives a first rendered image. The first hardware display controller engine can retrieve the image from a memory via a memory interface. The image may be transmitted on a bus between the memory and the first hardware display controller engine. This image may be created by a software task and stored in the memory. In one example embodiment, this image comprises a button bar.

In step 720, a second hardware display controller engine receives a second rendered image. The second hardware display controller engine can retrieve the image from a memory via a memory interface. The image may be transmitted on a bus between the memory and the second hardware display controller engine. This image may be created by a software task and stored in the memory.

In step 730, the first and second rendered images are transmitted to a first compositor. The hardware display controller engines can transmit their respective rendered images to the first compositor. In step 740, the first compositor composites the first and second rendered images to create a first composited image. The compositing operation may be performed by compositing software running on a CPU or a GPU.

In step 750, the first compositor outputs the first composited image. In some embodiments, the first composited image can be transmitted to a display panel for display. In other embodiments, the first composited image may be sent to a second compositor to be composited with one or more other images before being sent to a display.

In sum, dedicated hardware resources may be used to render images for display. A display controller may include hardware display controller engines for sending images to a display panel. The hardware, logic, and algorithms described above may be used to composite images such as button bars or status bars on a display. Embodiments of the present invention solve existing issues for displaying images.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

The invention claimed is:

1. A method for displaying images, comprising:
transmitting one or more images to a first compositor;
compositing the one or more images to create a first composited image;
transmitting a rendered image and the first composited image to a second compositor;
compositing the rendered image and the first composited image at the second compositor to produce a second composited image; and
transmitting the second composited image to a display.

2. The method of claim 1, wherein the one or more images transmitted to the first compositor are transmitted by one or more direct memory access engines.

3. The method of claim 1, wherein compositing the one or more images to create the first composited image comprises serially blending the one or more images based on visibility.

4. The method of claim 3, wherein the one or more images are blended in order of depth, beginning with the closest image and ending with the furthest image.

5. The method of claim 1, wherein the rendered image is transmitted to the second compositor by a first hardware display controller engine.

6. The method of claim 5, wherein at least one of the one or more images transmitted to the first compositor is transmitted by a second hardware display controller engine.

7. The method of claim 5, wherein each of the one or more images transmitted to the first compositor is transmitted by a separate hardware display controller engine.

8. The method of claim 1, wherein the rendered image comprises a button bar, a status bar, or a background image.

9. A system for displaying images, comprising:
a hardware display controller engine operable to receive a rendered image;
an output compositor operable to composite a first image and the rendered image to create a second composited image; and
a display operable to display the second composited image.

10. The system of claim 9, further comprising:
one or more direct memory access engines, wherein each of the direct memory access engines is operable to receive an image; and
a first compositor operable to composite two or more images received from the direct memory access engines to create the first image.

11. The system of claim 10, wherein compositing two or more images to create the first image comprises serially blending the two or more images based on visibility.

12. The system of claim 11, wherein the two or more images are blended in order of depth, beginning with the closest image and ending with the furthest image.

13. The system of claim 9, wherein the first image is transmitted to the output compositor by a second hardware display controller engine.

14. The system of claim 9, wherein the first image is a composite of at least two images, and wherein each of the at least two images are output by a separate hardware display controller engine.

15. The system of claim 14, wherein each of the at least two images are rendered images composited at a first compositor to create the first image.

16. The system of claim 9, wherein the rendered image comprises a button bar, a status bar, or a background image.

17. A computing device, comprising:
a memory; and
a processing unit coupled to the memory and including:
a subsystem configured for displaying images for the computing device, the subsystem having:
a hardware display controller engine operable to receive a rendered image;
an output compositor operable to composite a first image and the rendered image to create a second composited image; and
a display operable to display the second composited image.

18. The computing device of claim 17, the subsystem further comprising:
one or more direct memory access engines, wherein each of the direct memory access engines is operable to receive an image; and
a first compositor operable to composite two or more images received from the direct memory access engines to create the first image.

19. The computing device of claim 17, wherein the first image is transmitted to the output compositor by a second hardware display controller engine.

20. The computing device of claim 17, wherein the rendered image comprises a button bar, a status bar, or a background image.
